(19) United States
(12) Patent Application Publication
(10) Pub. No.: US 2025/0038516 A1
(43) Pub. Date: Jan. 30, 2025

(54) INTEGRATED CIRCUIT FOR BATTERY DISCONNECT

(71) Applicant: Rohm Co., Ltd., Kyoto (JP)

(72) Inventor: Mitchell G. Van Ochten, Milford, MI (US)

(21) Appl. No.: 18/360,538

(22) Filed: Jul. 27, 2023

(51) Int. Cl. H02H 3/087; B60L 3/04; H01H 47/00

(52) U.S. Cl. CPC H02H 3/087; B60L 3/04; H01H 47/002

(57) ABSTRACT

Systems and methods relating to battery disconnect units are disclosed. An example integrated circuit includes a first transistor operable for coupling to a first end of a coil of a DC contactor via a first pin, a second transistor operable for coupling to a second end of the coil of the DC contractor via a second pin, a third pin operable to receive an enable signal, wherein the second transistor is operable to be activated based on the enable signal and a timer operable to be activated based on the enable signal. The integrated circuit also includes circuitry operable to: in response to activating the second transistor, increase average current in the coil of the DC contactor to a first target level; in response to the timer indicating that a predetermined amount of time has elapsed, adjust the average current in the coil to a second target level, wherein the second target level is lower than the first target level; maintain an average current in the coil at the second target level until a disable signal is received via the third pin; and deactivate the second transistor in response to receiving the disable signal.

### FIELD OF THE DISCLOSURE

The present disclosure relates to a battery disconnect unit.

### BACKGROUND

This specification relates to battery disconnect units (BDU) used, for example, in hybrid, plug-in hybrid, and battery electric vehicles. BDUs are a type of high voltage power distribution unit and can serve as the primary interface between a vehicle's battery pack and electrical system.

### SUMMARY

This specification describes a system including a battery disconnect unit (BDU) integrated circuit that can efficiently distribute power over an electric vehicle system. The BDU integrated circuit can provide power to the coil of a DC contactor, which can connect or disconnect the electric vehicle battery to various circuits in the electric vehicle. In some implementations, the BDU integrated circuit can monitor the current in the contactor coil, generate a current delay, reduce the target current in the coil, and quickly switch off the current in the coil.

This specification describes a system including a battery disconnect unit (BDU) integrated circuit that can efficiently distribute power over an electric vehicle system. The BDU integrated circuit can provide power to the coil of a DC contactor, which can connect or disconnect the electric vehicle battery to various circuits in the electric vehicle. In some implementations, the BDU integrated circuit can monitor the current in the coil, generate a current delay, reduce the target current in the coil, and quickly switch off the current in the coil.

In one aspect, the present disclosure describes an integrated circuit that includes a first transistor operable for coupling to a first end of a coil of a DC contactor via a first pin, and a second transistor operable for coupling to a second end of the coil of the DC contractor via a second pin. A third pin is operable to receive an enable signal, wherein the second transistor is operable to be activated based on the enable signal. A timer also operable to be activated based on the enable signal. The integrated circuit further includes circuitry operable to: in response to activating the second transistor, increase average current in the coil of the DC contactor to a first target level; in response to the timer indicating that a predetermined amount of time has elapsed, adjust the average current in the coil to a second target level, wherein the second target level is lower than the first target level; maintain an average current in the coil at the second target level until a disable signal is received via the third pin; and deactivate the second transistor in response to receiving the disable signal.

Some implementations include one or more of the following features.

In some implementations, the second pin is operable for receiving a feedback signal and the integrated circuit includes circuitry to monitor the current in the coil of the DC contactor.

In some implementations, the integrated circuit further comprises circuitry operable to release the second transistor from the coil of the DC contactor in response to deactivating the second transistor.

In some implementations, the circuitry operable to adjust the average current in the coil of the DC contactor to a second target level comprises circuitry operable to adjust a duty cycle of the first transistor.

In some implementations, the circuitry operable to maintain an average current in the coil at the second target level comprises circuitry operable to adjust a duty cycle of the first transistor.

In some implementations, the circuitry operable to increase average current in the coil of the DC contactor to a first target level comprises circuitry operable to compare a voltage corresponding to the current through an external resistor that monitors the current in the coil with a reference voltage.

In some implementations, the integrated circuit is a part of an apparatus that includes a vehicle circuit, a DC contactor operable to connect or disconnect a high voltage battery to the vehicle circuit, the DC contactor including a coil having a first end and a second end; and the integrated circuit. The first transistor can be operable for coupling to the first end of the coil of the DC contactor via the first pin and the second transistor can be operable for coupling to the second end of the coil of the DC contractor via the second pin. The apparatus of claim can also include a microcontroller configured to provide the enable and disable signals to the third pin.

The present disclosure also describes a method for controlling current through a coil of a DC contactor including receiving an enable signal in an integrated circuit; in response to receiving the enable signal, activating a transistor and a timer in the integrated circuit, wherein, when activated, the transistor is coupled to one end of the coil; increasing average current in the coil to a first target level; in response to a predetermined amount of time elapsing based on a count of the timer, adjusting the average current in the coil to a second target level, wherein the second target level is lower than the first target level; maintaining an average current in the coil at the second target level; receiving a disable signal in the integrated circuit; and in response to receiving the disable signal, deactivating the transistor.

In some implementations, the method further comprising releasing the integrated circuit from the coil in response to deactivating the second transistor.

In some implementations, adjusting the current in the coil to a second target level comprises adjusting a duty cycle of the first transistor.

In some implementations, maintaining an average current in the coil at the second target level comprises adjusting a duty cycle of the first transistor.

In some implementations, increasing the current in the coil to a first target level comprises comparing a voltage corresponding to the current through a resistor that monitors the current in the coil with a reference voltage.

The subject matter described in this specification can be implemented in particular embodiments so as to realize one or more of the following advantages.

Current BDU units use discrete components, which may require a large number of passive components and components that operate at a low operating frequency. Implementing the BDU functions in an integrated circuit can, in some cases, reduce the amount of printed circuit board (PCB) space required for a BDU as well as the number of external passive components, while increasing the operating frequency of the BDU.

The details of one or more implementations of the subject matter of this specification are set forth in the accompanying drawings and the description below. Other, aspects, features and advantages will be readily apparent from the following detailed description, the accompanying drawings, and the claims.

### BRIEF DESCRIPTION OF THE DRAWINGS

FIG. 1 shows an example of an integrated circuit system 100 for use in an electric vehicle.

FIG. 2 shows an example BDU system.

FIG. 3 shows an example timing diagram for the BDU system of FIG. 2A.

FIG. 4 is a flow chart showing an example process for controlling current through the coil of a DC contactor.

### DETAILED DESCRIPTION

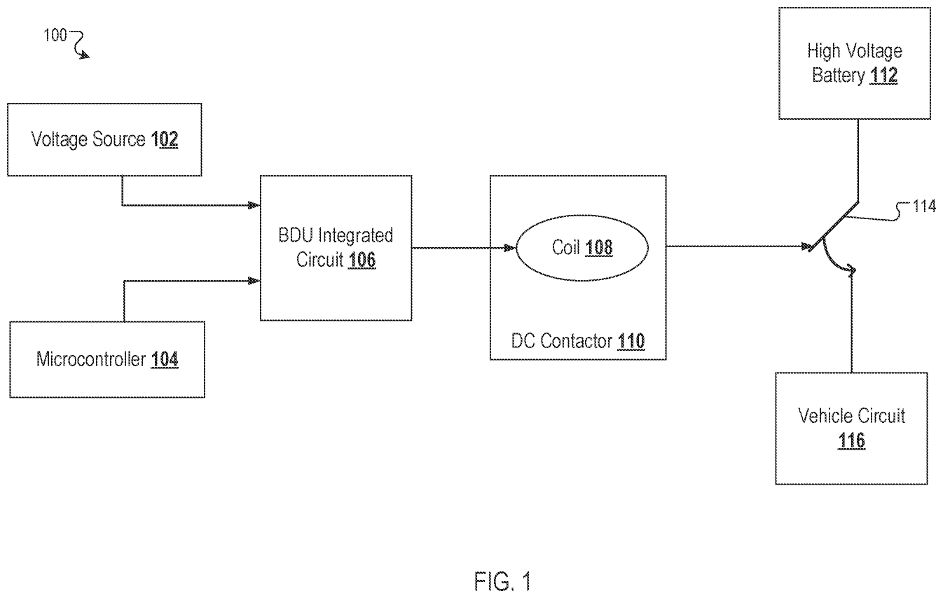

FIG. 1 shows an example of an integrated circuit system 100 for use in an electric vehicle. The electric vehicle can be a hybrid, plug-in hybrid, or battery electric vehicle. The integrated circuit system 100 includes a voltage source 102 and a microcontroller 104 that are coupled to a battery disconnect unit (BDU) 106 that can be implemented as an integrated circuit. The BDU integrated circuit 106 is coupled to a coil 108 of a DC contactor 110, which controls the state of an electromechanical or other switch 114. That is, the DC contactor 110 is operable to connect or disconnect a high voltage battery 112 to one or more vehicle circuits 116 via the switch 114. One end of the switch 114 connects to the high voltage battery 112. When the switch 114 is closed, the second end of the switch 114 connects to a vehicle circuit 116, which can be any appropriate circuit of the electric vehicle (e.g., an air conditioning compressor, cabin heater, or traction inverter). When the switch 114 is open, the second end of the switch 114 is disconnected from the vehicle circuit 116.

In operation, the voltage source 102 applies a battery voltage to the BDU integrated circuit 106. The battery voltage can be a predetermined initial voltage, e.g., 12V.

The microcontroller 104 provides automated control for the BDU integrated circuit 106. The microcontroller 104 can include one or more CPUs, memory, and programmable input/output peripherals.

The BDU integrated circuit 106 provides power to the DC contactor 110 by adjusting the current in the coil 108 of the DC contactor. The BDU integrated circuit 106 serves as the primary interface between a vehicle's electrical system and battery pack. The BDU integrated circuit 106 is designed, in some cases, to distribute power efficiently throughout the electric vehicle system.

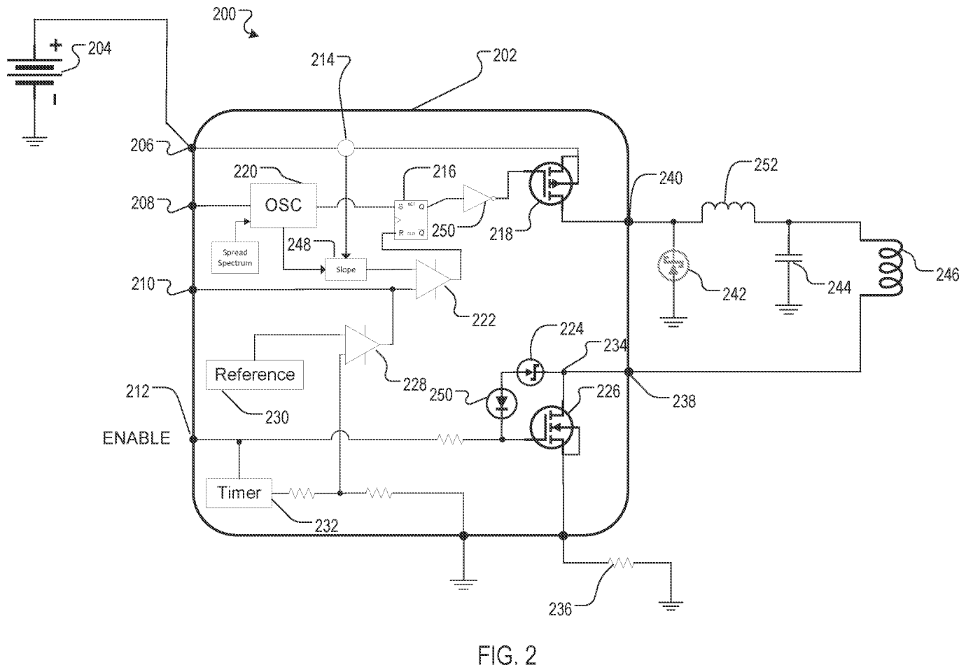

FIG. 2 shows an example BDU system 200 including a voltage source 204, a BDU integrated circuit 202, and a coil 246 of a DC contactor. The BDU integrated circuit 202 illustrates details in accordance with a particular implementation of the BDU integrated circuit 106 of FIG. 1. The voltage source 204 is operable to apply an initial voltage to the BDU integrated circuit 202 via an input voltage pin 206 of the BDU integrated circuit. The voltage source 204 can have a predetermined initial voltage, e.g., 12V.

As shown in FIG. 2, the BDU integrated circuit 202 includes a first transistor 218 operable for coupling to a first end of the coil 246 via a first pin 240, a second transistor 226 operable for coupling to a second end of the coil 246 via a second pin 238, a timer 232, and a third pin 212 operable to receive an enable signal. The second transistor 226 and the timer 232 are both operable to be activated based on the enable signal. The first and second transistors can be any appropriate type of transistor, e.g., a MOSFET.

In operation, initially, the current through the coil 246 of the DC contactor is zero, and the first transistor 218 and second transistor 226 are turned off. When the voltage source 204 applies the initial voltage to the BDU integrated circuit 202 via the voltage pin 206, the first transistor is activated. The BDU integrated circuit 202 can include circuitry operable to turn on the first transistor 218. For example, the BDU integrated circuit 202 can include a flip flop 216 having an output that can turn the first transistor 218 on and off. A buffer 250 may be present between the output of the flip flop 216 and the gate of the first transistor 218. The current through the coil 246 remains at zero while the first transistor 218 is turned on, but the second transistor 226 is turned off.

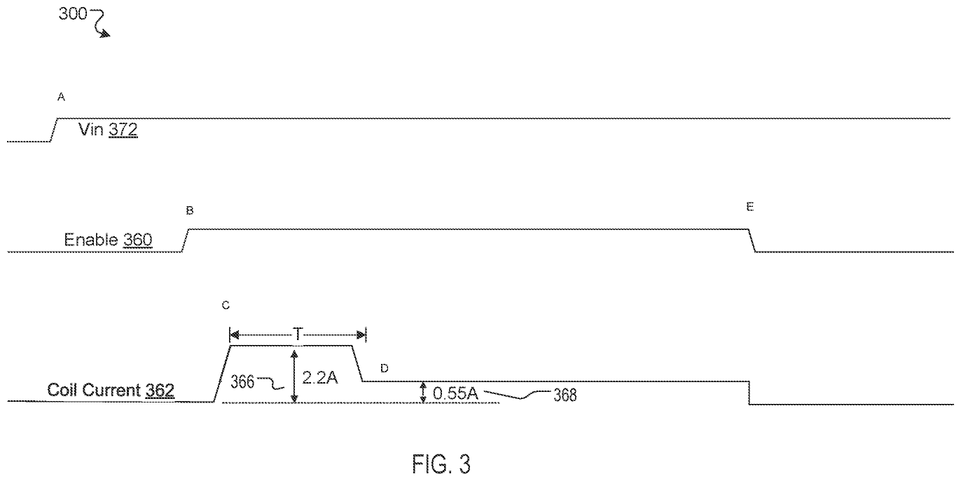

FIG. 3 shows an example timing diagram 300 for the BDU system of FIG. 2. The timing diagram includes a voltage lifeline 372, an enable signal lifeline 360, and a coil current lifeline 362. The voltage lifeline 372 shows the voltage over time at the voltage pin 206. The enable signal lifeline 360 shows the enable signal over time at the third pin 212. The coil current lifeline 362 shows the current through the coil 246 over time. In the illustrated example, the voltage lifeline 372 and the coil current lifeline 362 have initial values of zero, while the enable signal lifeline 360 has an initial value of ‘LOW’.

As shown in FIG. 3, the voltage lifeline 372 indicates that the voltage increases when the voltage source 204 applies initial voltage to the BDU integrated circuit 202 at time A. For example, the when the initial voltage is 12V, the initial voltage lifeline 372 increases to 12V. Though initial voltage has been applied to the BDU integrated circuit 202 at time point A, the coil current 362 initially remains at zero.

When the enable signal (controlled by the microcontroller 104) subsequently goes high, the second transistor 226 and the timer 232 are activated. The BDU integrated circuit 202 includes circuitry operable to increase current in the coil 246 to a first target level 366 in response to activating the second transistor 226. When the second transistor 226 is activated, the current through the coil 246 increases until it reaches the predetermined first target level 366. For example, in the illustrated example, current through the coil 246 increases until it equals a first predetermined target level 366 of 2.2 amperes. At time B, the enable signal goes to “HIGH”. At time C, after time B, the coil current 362 rises to the first target level I₁ 366. The coil current 362 remains at the first target level I₁ 366 until time D, as discussed below.

To increase the current through the coil 246 to the first target level, the BDU integrated circuit can include an error op amp 228 that modulates the ON time of the first transistor 218 as needed to get the average current through the coil 246 to the first target level. The error op amp 228 is operable to compare a voltage corresponding to the current through an external current sense resistor 236 (which monitors the current in the coil 246) with a reference voltage 230. In some implementations, the reference voltage is 0.8 volts. Current flowing through the external current sense resistor 236 is indicative of the coil current received via the second pin 238.

The BDU integrated circuit 202 also can include circuitry operable to maintain the average current through the coil 246 at the first target level. A resistor at the output of the timer 232 takes current from the summing junction of the error op amp 228, which forces the error op amp 228 to be satisfied only when the current through the coil 246 is at the first target level. An output of the error op amp 228 is coupled to a comparator op amp 222 that is operable to adjust the duty cycle of the first transistor 218 so as to maintain the average current through the coil 246 at the first target level. The flip flop 216 receives inputs from an oscillator 220 and the comparator op amp 222 to turn the first transistor 218 on and off in accordance with the specified duty cycle.

In some implementations, an inductor 252 is coupled between the first transistor 218 and the coil 246. When the first transistor 218 turns off, the voltage across the inductor 252 reverses. A catch diode 242 provides a path for current through the inductor when the voltage across the inductor reverses. The inductor 252 along with the catch diode 242 and a capacitor 244 are operable to smooth the output of the first pin 240 before it reaches the coil 246.

The BDU integrated circuit 202 includes circuitry operable to adjust the current through the coil to a second predetermined first target level in response to the timer indicating that a predetermined amount of time T has elapsed. For example, in some implementations, the predetermined time is 100 ms. The second target level is lower than the first target level. After the predetermined amount of time has elapsed, the timer 232 sources current instead of sinking current. As a result, the error op amp 228 registers that the current is too high and adjusts the duty cycle of the first transistor 218 so that the current through the coil 246 decreases to the second target level. For example, the comparator op amp 222 can adjust the duty cycle of the first transistor 218 until the current through the coil 246 reaches a predetermined second target level 368, which in the illustrated example can be, e.g., 0.55 amperes. The coil current 362 remains at the first target level 366 for the predetermined amount of time T and then at time D, the coil current decreases to the second target level 368. The values of the predetermined first and second target levels may differ from the from the foregoing values in some implementations.

The BDU integrated circuit 202 is operable to maintain an average current in the coil 246 at the second target level until a disable signal is received via pin 212. In particular, the comparator op amp 222 adjusts the duty cycle of the first transistor 218 to maintain the current through the coil 246 at the second target level.

When a disable signal (from the microcontroller 104) is received via pin 212, the second transistor 226 is deactivated. The enable signal 360 goes back to ‘LOW’ at time E and the coil current 362 decreases to zero.

When the second transistor 226 is deactivated, a voltage spike may occur. The BDU integrated circuit 202 can include a Zener diode 224 coupled between the drain and gate of the second transistor 226. The diode 224 allows the second transistor 226 to remain on until the current drops and the voltage goes to zero. That is, the diode 224 can prevent the drain voltage of the second transistor 226 from reaching avalanche when the first transistor 218 is turned off. This allows the contactor to disconnect quickly and can prevent damage to the second transistor 226 as a result of the voltage spike. More specifically, when the circuitry deactivates the second transistor 226, the energy through the coil 246 dissipates, and the DC contactor rapidly releases. The bottom end of the coil 246 transitions to a positive voltage and produces a high voltage at the drain 234 of the second transistor 226. The diode 224 prevents the drain voltage from rising until it reaches an avalanche condition by limiting how far the drain 234 voltage can rise. This allows rapid deactivation of the second transistor 226 and release of the DC contactor without damage.

In some implementations, the BDU integrated circuit 202 includes a fourth pin 210 coupled to the error op amp 228. In some implementations, it may be desirable to perform compensation to keep the system 200 stable. The fourth pin 210 can be coupled, for example, to resistors and capacitors as needed to control the gain of the error op amp 228.

In some implementations, the BDU integrated circuit 202 includes a fifth pin 208 coupled to an oscillator 220. The fifth pin 208 can receive a signal to set the operating frequency of the first transistor 218 to a fixed value. The oscillator 220 is coupled to the comparator op amp 222 and to an input of the flip flop 216. The oscillator 220 generates a ramp signal in slope circuitry 248. Intersection of the ramp signal with the output from the error op amp 228 provides control of the comparator op amp 222.

In some implementations, the BDU integrated circuit 202 includes circuitry operable to sense the current in the first transistor 218. A current sensor 214 can sample the current in the first transistor 218. In some implementations, sampling the current can protect the BDU integrated circuit 202 from an overcurrent condition if the load is shorted. In some examples, the sampled current is combined with the slope 248 and sent to the comparator op amp 222.

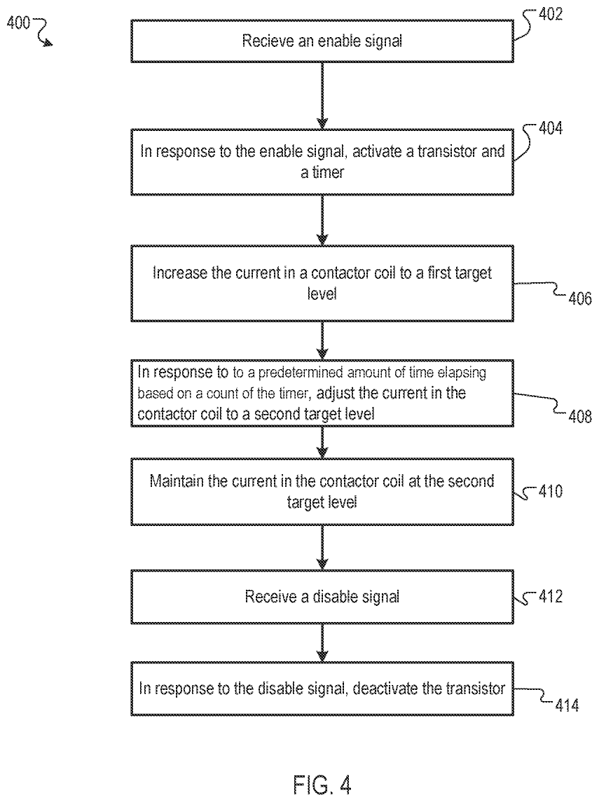

FIG. 4 is a flow chart showing an example process 400 for controlling current through the coil of a DC contactor. The process 400 can be performed by any appropriate system, e.g., the BDU system 200 of FIG. 2, which includes a coil of a DC contactor and the integrated circuit 202. Each end of the coil can be coupled to a different transistor on an integrated circuit. Before receiving an enable signal, a first transistor already can be activated. When only the first transistor is activated, the current through the coil is zero. When both the first and the second transistors are activated, current can flow through the coil.

As indicated by 402, the integrated circuit receives an enable signal. In response to receiving the enable signal, the system activates the second transistor and a timer on the integrated circuit (404). When activated, the second transistor is coupled to the coil of the DC contactor.

When the second transistor is activated, the average current through the coil increases until it reaches a first predetermined target level (e.g., 2.2 amperes) (406). The system maintains an average current in the coil at the first target level. After a predetermined amount of time has elapsed based on a count of the timer, the system adjusts the current in the coil to a second predetermined target level (e.g., 0.55 amperes) (408), where the second target level is lower than the first target level. The system maintains an average current in the coil at the second target level (410).

At some later time, the integrated circuit receives a disable signal (412). In response to receiving the disable signal, the second transistor is deactivated (414). As a result, the energy stored in the coil rapidly dissipates and the contactor is rapidly released. The bottom end of the coil transitions to a positive voltage, which produces a high voltage at the drain of the second transistor. The system can include, for example, a Zener diode to prevent the voltage from reaching an avalanche condition. This feature can, in some implementations, help avoid damage to the second transistor. The contactor can be released quickly in order to prevent its parts from arcing.

While particular implementations of the present invention have been described above, these are for illustrative purposes, and various modifications may be made without departing from the spirit or scope of the disclosure. Accordingly, other implementations also are within the scope of the claims.

1. An integrated circuit comprising:
a first transistor operable for coupling to a first end of a coil of a DC contactor via a first pin;
a second transistor operable for coupling to a second end of the coil of the DC contractor via a second pin;
a third pin operable to receive an enable signal, wherein the second transistor is operable to be activated based on the enable signal;
a timer operable to be activated based on the enable signal;
circuitry operable to:
in response to activating the second transistor, increase average current in the coil of the DC contactor to a first target level;
in response to the timer indicating that a predetermined amount of time has elapsed, adjust the average current in the coil to a second target level, wherein the second target level is lower than the first target level;
maintain an average current in the coil at the second target level until a disable signal is received via the third pin; and
deactivate the second transistor in response to receiving the disable signal.

2. The integrated circuit of claim 1, wherein the second pin is operable for receiving a feedback signal, the integrated circuit including circuitry to monitor the current in the coil of the DC contactor.

3. The integrated circuit of claim 1, further comprising circuitry operable to release the second transistor from the coil of the DC contactor in response to deactivating the second transistor.

4. The integrated circuit of claim 1, wherein the circuitry operable to adjust the average current in the coil of the DC contactor to a second target level comprises circuitry operable to adjust a duty cycle of the first transistor.

5. The integrated circuit of claim 1, wherein the circuitry operable to maintain an average current in the coil at the second target level comprises circuitry operable to adjust a duty cycle of the first transistor.

6. The integrated circuit of claim 1, wherein the circuitry operable to increase average current in the coil of the DC contactor to a first target level comprises circuitry operable to compare a voltage corresponding to the current through an external resistor that monitors the current in the coil with a reference voltage.

7. An apparatus comprising:
a vehicle circuit;
a DC contactor operable to connect or disconnect a high voltage battery to the vehicle circuit, the DC contactor including a coil having a first end and a second end; and
the integrated circuit of claim 1, wherein the first transistor is operable for coupling to the first end of the coil of the DC contactor via the first pin and wherein the second transistor is operable for coupling to the second end of the coil of the DC contractor via the second pin.

8. The apparatus of claim 7 further including a microcontroller configured to provide the enable and disable signals to the third pin.

9. A method for controlling current through a coil of a DC contactor, the method comprising:
receiving an enable signal in an integrated circuit;
in response to receiving the enable signal, activating a transistor and a timer in the integrated circuit, wherein, when activated, the transistor is coupled to one end of the coil;
increasing average current in the coil to a first target level;
in response to a predetermined amount of time elapsing based on a count of the timer, adjusting the average current in the coil to a second target level, wherein the second target level is lower than the first target level;
maintaining an average current in the coil at the second target level;
receiving a disable signal in the integrated circuit; and
in response to receiving the disable signal, deactivating the transistor.

10. The method of claim 9 further comprising releasing the integrated circuit from the coil in response to deactivating the second transistor.

11. The method of claim 9, wherein adjusting the current in the coil to a second target level comprises adjusting a duty cycle of the first transistor.

12. The method of claim 9, wherein maintaining an average current in the coil at the second target level comprises adjusting a duty cycle of the first transistor.

13. The method of claim 9, wherein increasing the current in the coil to a first target level comprises comparing a voltage corresponding to the current through a resistor that monitors the current in the coil with a reference voltage.
